(19) United States
(12) Patent Application Publication
(10) Pub. No.: US 2024/0344384 A1
(43) Pub. Date: Oct. 17, 2024

(54) THERMAL BREAK FOR A FENESTRATION UNIT

(71) Applicant: Pella Corporation, Pella, IA (US)

(72) Inventors: Andrew Morse, Pella, IA (US); Shawn Smothers, Pella, IA (US); Mohammad Abdelrahim, Pella, IA (US); Evan Vande Haar, Pella, IA (US); Joshua Zehner, Pella, IA (US)

(73) Assignee: Pella Corporation, Pella, IA (US)

(21) Appl. No.: 18/637,534

(22) Filed: Apr. 17, 2024

Related U.S. Application Data
(60) Provisional application No. 63/459,788, filed on Apr. 17, 2023.

(51) Int. Cl. E06B 3/263; E05D 15/06; E06B 3/12; E06B 3/46; E06B 3/70; E06B 3/72

(52) U.S. Cl. CPC E06B 3/26347; E05D 15/0665; E06B 3/12; E06B 3/26305; E06B 3/4636; E06B 3/72; E05Y 2900/132; E06B 2003/26312; E06B 3/26343; E06B 2003/2635; E06B 2003/26369; E06B 2003/26387; E06B 2003/7076

(57) ABSTRACT

Devices, systems, and methods related to a fenestration unit are described herein. The fenestration unit may include a frame including a plurality of frame members, wherein the plurality of frame members includes an upper rail member, a lower rail member, a first stile member, a second stile member, the lower rail member including two parallel metallic extrusions a space defined therebetween and a thermal break coupled to the lower rail member and located within the space. The thermal break may include a solid body of thermally insulating material defining a first side portion, a second side portion, and an intermediate portion between the first side portion and the second side portion, the solid body of thermally insulating material being asymmetrical about an X-Y plane.

### CROSS-REFERENCE TO RELATED APPLICATIONS

This application claims priority to U.S. Provisional Patent Application No. 63/459,788, filed Apr. 17, 2023, the disclosure of which is hereby incorporated by reference in its entirety.

### BACKGROUND

Homeowners may install fenestration units into their homes for a variety of reasons including for ventilation or for ingress and egress. In general, when installed in a home, fenestration units can provide a barrier between an inside of the home and the outside environment. Depending on the season, the inside of the home and the outside environment may greatly vary in temperature and the fenestration unit may be exposed to a heat differential between the inside and outside. However, the fenestration unit may need to resist temperature changes from the outside environment such that the inside of the home is unaffected and to avoid other unwanted results.

### SUMMARY

A fenestration unit including a thermal break, or a thermal break system is disclosed within. In some embodiments, the thermal break is coupled to a frame (e.g., a metallic frame). In some embodiments, the thermal break is coupled to a panel (e.g., a metallic panel). In some embodiments, the thermal break system includes a plurality of thermal breaks coupled to at least one of the frame or the panel, where the plurality of thermal breaks are aligned along an isothermal plane. The thermal break and/or thermal break system may reduce heat transfer through the frame and/or the panel to improve insulation inside a building (e.g., a home). The thermal break and/or thermal break system may also reduce natural convention or heat transfer through the frame and/or panel. For example, the thermal break and/or thermal break system may reduce heat loss from inside the building to the outside the building during the winter. In some embodiments, the fenestration unit disclosed herein has improved insulation and may lead to energy savings.

According to one example (“Example 1”), a fenestration unit comprises a frame including a plurality of frame members, wherein the plurality of frame members includes an upper rail member, a lower rail member, a first stile member, a second stile member, the lower rail member including two parallel metallic extrusions a space defined therebetween and a thermal break coupled to the lower rail member, the thermal break located within the space, the thermal break including a solid body of thermally insulating material defining a first side portion, a second side portion, and an intermediate portion between the first side portion and the second side portion, the solid body of thermally insulating material being asymmetrical about an X-Y plane.

According to another example (“Example 2”), further to Example 1, the thermally insulating material includes at least one of polyamide, polyurethane, and fiberglass.

According to another example (“Example 3”), further to Example 1, the thermal break is a solid, extruded member.

According to another example (“Example 4”), further to Example 1, the fenestration unit further includes a panel coupled to the frame, the panel including a set of rollers coupled to a bottom side of the panel, the set of rollers engaged with the thermal break.

According to another example (“Example 5”), further to Example 4, the intermediate portion of the solid body of thermally insulating material defines a convex crown, the convex crown defining a roller track to engage the set of rollers of the panel.

According to another example (“Example 6”), further to Example 5, the convex crown further includes a cap member coupled to the convex crown, the cap member operable to engage the set of rollers.

According to another example (“Example 7”), further to Example 6, the cap member includes a low-friction material.

According to another example (“Example 8”), further to Example 1, the first side portion of the solid body of thermally insulating material defines a first protrusion and the second side portion of the solid body of thermally insulating material defines a second protrusion, the first protrusion and the second protrusion configured to couple to at least one of the two parallel metallic extrusions of the lower rail member.

According to another example (“Example 9”), further to Example 1, the intermediate portion of the solid body of thermally insulating material defines a rounded opening.

According to another example (“Example 10”), further to Example 9, the rounded opening is configured to removably couple to an end plate of the fenestration unit.

According to one example (“Example 11”), a fenestration unit comprises a frame including a plurality of frame members, wherein the plurality of frame members includes an upper rail member, a lower rail member, a first stile member, a second stile member, the lower rail member including a first metallic extrusion and a second metallic extrusion positioned opposite the first metallic extrusion, the first and second metallic extrusions defining a space therebetween and a thermal break coupled to the lower rail member, the thermal break located within the space, the thermal break including a body of thermally insulating material defining a first side portion, a second side portion, and an intermediate portion between the first side portion and the second side portion, the first side portion defines a first horizontal protrusion coupled to the first metallic extrusion and the second side portion defines a second horizontal protrusion coupled to the second metallic extrusion, and the first side portion and the second side portion are asymmetrical about an X-Y plane.

According to another example (“Example 12”), further to Example 11, a length of the first horizontal protrusion is less than a length of the second horizontal protrusion.

According to another example (“Example 13”), further to Example 11, the second horizontal protrusion further includes a vertical protrusion projecting perpendicularly to the second horizontal protrusion.

According to another example (“Example 14”), further to Example 11, the fenestration unit further includes a sliding panel coupled to the frame, the sliding panel including a set of rollers coupled to a bottom side of the sliding panel, the set of rollers engaged with the thermal break.

According to one example (“Example 15”), a fenestration unit comprises a frame including a plurality of frame members including an upper rail member, a lower rail member, a first stile member, a second stile member, the lower rail member including two metallic extrusions on either side of the rail with a space defined therebetween, a panel coupled to the frame, the panel including an upper side defined along the upper rail member, a lower side defined along a lower rail member, a first side defined along the first stile member, and a second side defined along the second stile member, the panel including a set of rollers coupled along the lower side, an insulated glass unit supported within the panel, and a thermal break system defined along an isothermal plane of the fenestration unit, the thermal break system including a first thermal break coupled lengthwise along the lower rail member of the frame, the first thermal break including a first body of thermally insulating material, the first body being asymmetrical about a longitudinal axis, and a second thermal break defined along a lower side of the panel proximate to the set of rollers, the second thermal break including a second body of thermally insulating material, wherein the first thermal break and the second thermal break are aligned along the isothermal plane.

According to another example (“Example 16”), further to Example 15, the second body of thermally insulating material includes a first side portion and a second side portion, the first side portion and the second side portion defining a plurality of protrusions configured to couple to the panel.

According to another example (“Example 17”), further to Example 16, the second body of thermally insulating material further includes a plurality of recesses is configured to receive a seal coupled lengthwise along the lower rail of the frame.

According to another example (“Example 18”), further to Example 15, the set of rollers is engaged with the first thermal break.

According to another example (“Example 19”), further to Example 15, the thermal break system further includes a third thermal break defined lengthwise along the panel proximate to the insulated glass unit.

According to another example (“Example 20”), further to Example 19, the first thermal break, the second thermal break, and the third thermal break are aligned along the isothermal plane.

The foregoing Examples are just that and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is a front view of a fenestration unit for installation in a building structure, in accordance with some embodiments;

FIG. 2 is a front view of a panel of the fenestration unit of FIG. 1, in accordance with some embodiments;

FIG. 3 is an isometric view of a lower rail member of the frame, in accordance with some embodiments;

FIG. 4A is an end view showing the end plate 52 as coupled at the first end 51 of the lower rail member 18, in accordance with some embodiments;

FIG. 4B is an end view of a portion of the lower rail member 18 showing the first end 51 of the lower rail member 18 with the end plate 52 removed, in accordance with some embodiments;

FIG. 5 is a front view of a first track of the lower rail member, in accordance with some embodiments;

FIG. 6 is a front view of a set of rollers engaged with the lower rail member, in accordance with some embodiments;

FIG. 7 is an end view or sectional view of a thermal break, in accordance with some embodiments;

FIG. 8 is a front view of a thermal break system, in accordance with some embodiments;

FIG. 9A-9B are front views of a second thermal break of the thermal break system of FIG. 8, in accordance with some embodiments; and

FIG. 10 is a front view of a third thermal break of the thermal break system of FIG. 8, in accordance with some embodiments.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

The terms “interior” and “exterior” are generally meant to reference opposite sides of a fenestration unit unless directly specified that “exterior” means exposed to the elements. For example, a fenestration unit installed within an interior of a building structure (e.g., a bedroom door) still has opposing “interior” and “exterior” sides as those terms are used in this patent specification, though the “exterior” is still disposed within the building structure itself.

The term “fenestration unit” is meant to cover any of a variety of products for providing venting, viewing, ingress, or egress from a building structure into which the fenestration unit is installed. Examples include doors, windows, and the like.

The terms “building” or “structure” are meant to cover any of a variety of structures. Examples include single-or multi-family homes, residential buildings, commercial buildings, and others.

The term “opening” as used in the context of a “building” or “structure” may include rough openings in the building, including rough openings in an exterior wall or boundary of the structure or internal wall or boundary of the structure.

Relative terms such as “upper”, “lower”, “top”, “bottom”, “horizontal,” “vertical”, “left”, “right” and the like are construed broadly and are used to describe the orientation of components relative to one another, rather than in an absolute sense, unless otherwise indicated.

### Description of Various Embodiments

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale but may be exaggerated to illustrate various aspects of the present disclosure, and in that regard, the drawing figures should not be construed as limiting.

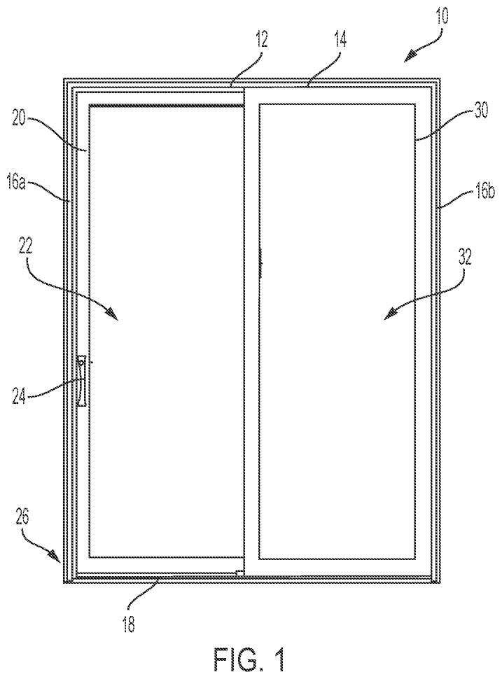

FIG. 1 is a front view of a fenestration unit 10 for installation in a building structure (not shown), in accordance with an embodiment. FIG. 1 depicts the fenestration unit 10 as would be viewed from an interior side of the building structure. As shown, the fenestration unit 10 includes a frame 12. The frame 12 may include a plurality of frame members including an upper rail member 14, a first stile member 16a, a second stile member 16b, and a lower rail member 18. The first stile member 16a and the lower rail member 18 may define a corner 26 at the intersection of the first stile member 16a and the lower rail member 18. However, the corner 26 may be formed and defined at any of the intersections between the upper rail member 14, the first stile member 16a, the second stile member 16b, and the lower rail member 18.

The frame 12 and its components may be installed in the opening of the building structure and support a set of panels 20, 30 of the fenestration unit 10. In some embodiments, the panel 20 is a sliding panel 20 and panel 30 is a fixed panel 30. In other embodiments, the reverse configuration is contemplated. In still further embodiments, the set of panels 20, 30 of the fenestration unit 10 are both sliding panels. The panel 20 may support a glazing unit 22 and the panel 30 may support a glazing unit 32. In some embodiments, the glazing units 22, 32 are insulated glass units. Alternatively, one or both of the glazing units 22, 32 may be replaced with any of a variety of alternative inserts, including solid, non-transparent inserts made of wood, metal, plastic, or any of a variety of materials. The fenestration unit may further include a handle 34. Although the fenestration unit 10 depicted is a sliding door, it is understood that the fenestration unit 10 described herein may also be implemented with respect to sliding windows.

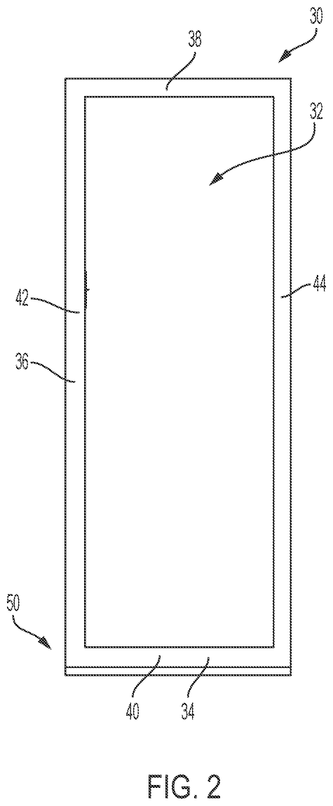

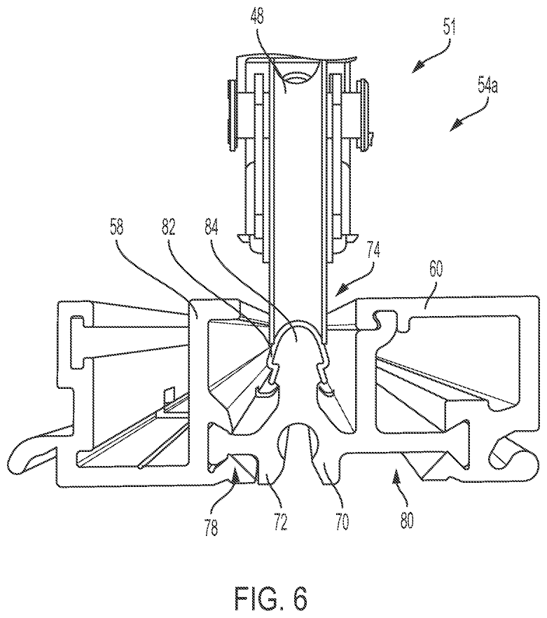

FIG. 2 is a front view of the panel 30 of the fenestration unit 10 of FIG. 1, in accordance with an embodiment. In some embodiments, the panel 30 is the sliding panel 30. In other embodiments the panel 30 is the fixed panel 30. The panel 30 may include an upper side 38, a lower side 40, a first side 42, and a second side 44. The upper side 38 may be defined along the upper rail member 14 of the frame 12, the lower side 40 may be defined along the lower rail member 18 of the frame 12, the first side 42 may be defined along the first stile member 16a of the frame 12, and the second side 44 may be defined along the second stile member 16b of the frame 12. In some embodiments, the panel 30 includes a set of rollers 48 (e.g., as shown in FIG. 6) coupled along the lower side 40. In some embodiments, the panel 30 supports the glazing unit 32.

Further to FIG. 2, the panel 30 may include a horizontal member 34 (e.g., a rail) and a vertical member 36 (e.g., a stile). In some embodiments, the horizontal member 34 is the lower side 40 and the vertical member 36 is the first side 42. However, it is understood that the horizontal member 34 may be the upper side 38 and the vertical member 36 may be the second side 44, or any combination thereof. The horizontal member 34 and the vertical member 36 may intersect at a corner 50. The corner 50 may be a coupling between the vertical member 36 and the horizontal member 34. The corner 50 may be defined at the lower side 40 and first side 42 of the panel 30. However, it is understood that the corner 50 may be formed at the intersection of any combination of the upper side 38, the lower side 40, the first side 42, and the second side 44.

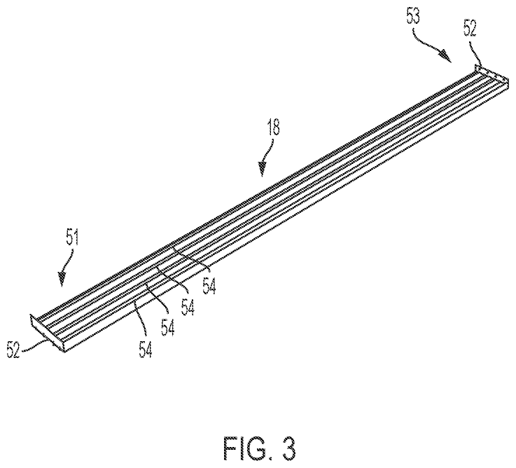

FIG. 3 is an isometric view of the lower rail member 18 of the frame 12, in accordance with some embodiments. The lower rail member 18 includes a first end 51 and a second end 53. The first end 51 may be proximate to the corner 50 (e.g., as shown in FIG. 2). The lower rail member 18 may define a plurality of tracks 54 and the plurality of tracks 54 may extend lengthwise between the first end 51 of the lower rail member 18 and the second end 53 of the lower rail member 18. Although four tracks are shown in the plurality of tracks 54, the plurality of tracks 54 can include more than four tracks or less than four tracks. The lower rail member 18 may further include an end plate 52 removably coupled to at least one of the first end 51 and the second end 52. In some embodiments, the end plate 52 is removably coupled to the plurality of tracks 54.

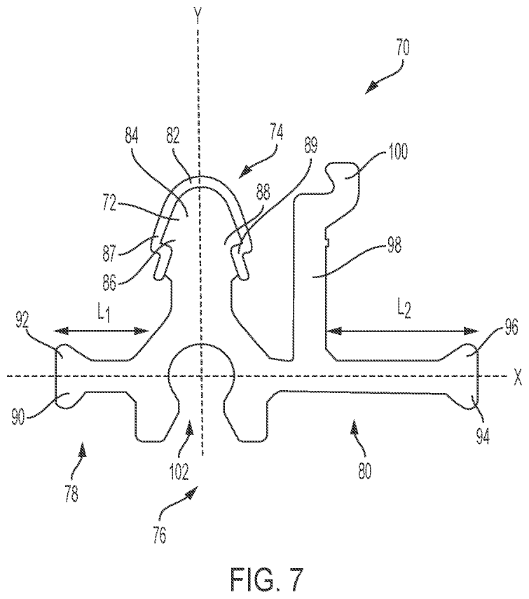

In some embodiments, the plurality of tracks 54 may be operable to support the panels 20, 30 of the fenestration unit 10. The panel 30 may be a sliding panel and have a set of rollers 48 coupled to a bottom side 40 of the panel 30 (e.g., as shown in FIGS. 6-7). The set of rollers 48 may be configured to slidably engage with at least one of the tracks of the plurality of tracks 54.

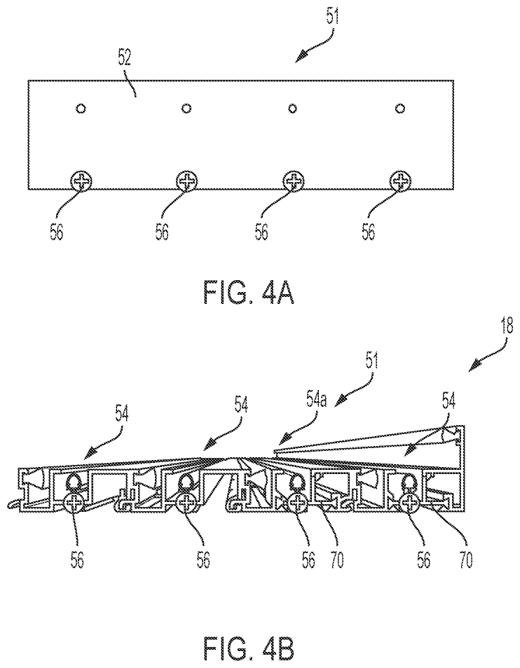

FIG. 4A is an end view showing the end plate 52 as coupled at the first end 51 of the lower rail member 18, in accordance with some embodiments. In some embodiments, the end plate 52 is removably coupled to each track in the plurality of tracks 54 via one or more fasteners 56.

FIG. 4B is an end view of a portion of the lower rail member 18 showing the first end 51 of the lower rail member 18 with the end plate 52 removed, in accordance with some embodiments. In some embodiments, each track in the plurality of tracks 54 is operable to receive the one or more fasteners 56 of the end plate 52. In some embodiments, the plurality of tracks 54 are configured to couple together to form the lower rail member 18. In some embodiments, at least one of the tracks in the plurality of tracks 54 includes a thermal break 70 (e.g., a first track 54a). In some embodiments, the at least one track in the plurality of tracks 54 that includes the thermal break 70 is located at an interior of the building structure (e.g., inside). The thermal break 70 located at the interior of the building structure may provide insulation and help prevent loss of heat through the frame 12 to the exterior of the building structure (e.g., from heat transfer between metallic elements of the frame 12). In further embodiments, the thermal break 70 can be located at each track in the plurality of tracks 54.

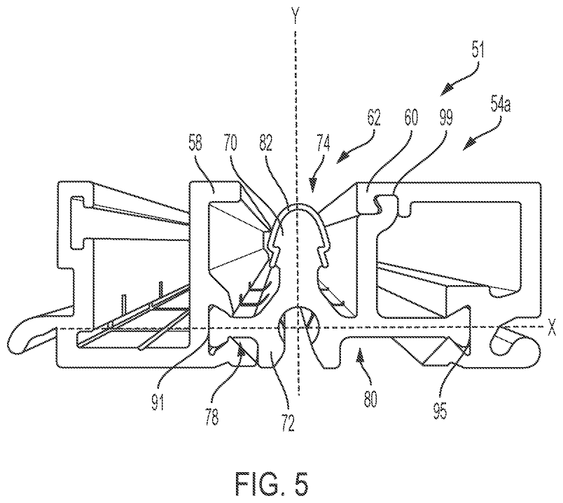

FIG. 5 is a front view of the first track 54a in the plurality of tracks 54 of the lower rail member 18, in accordance with some embodiments. Although the first track is shown in FIG. 5, the first track 54a may be substantially similar to each track in the plurality of tracks 54. Although shown with respect to the first end 51 of the lower rail member 18, the second end 53 may be substantially similar. The first track 54 may define a first lower rail member 58 and a second lower rail member 60. In some embodiments, the first lower rail member 58 and the second lower rail member 60 may be parallel to each other. In some embodiments, the first lower rail member 58 and the second lower rail member 60 may be metallic extrusions (e.g., aluminum extrusions). A space 62 may be formed between the first and second lower rail members 58, 60. In some embodiments, a thermal break 70 may be located within the space 62. The thermal break 70 may be coupled to the lower rail member 18. In some embodiments, the thermal break may be coupled to at least one, or both, of the first and second lower rail members 58, 60. The thermal break 70 may be permanently coupled to the frame 12 by crimping the thermal break 70 into place. In some embodiments, the first and second lower rail members 58, 60, the thermal break 70, and the space 62 may extend along lengthwise between the first end 51 and the second end 53 of lower rail member 18.

Further to FIG. 5, the thermal break 70 may include a body of thermally insulating material 72. The body of thermally insulating material 72 may be solid. The body of thermally insulating material 72 may define a first side portion 78, a second side portion 80, and an intermediate portion 74 located between the first side portion 78 and the second side portion 80. In some embodiments, the body of thermally insulating material 72 is asymmetric about an X-Y plane defined generally between a vertical axis Y and a horizontal axis X. The X-Y plane may be defined generally centrally to the body of thermally insulating material 72 (e.g., generally centrally through the intermediate portion 74 and generally centrally through the first side portion 78 and the second side portion 80). In some embodiments, the thermal break 70 is solid and/or is an extruded member. In some embodiments, the thermal break 70 further includes a cap member 82 removably coupled to the body of thermally insulating material 72. The cap member 82 may be removably coupled to the intermediate portion 74 of the body of thermally insulating material 72. In other embodiments, the cap member 82 may be integral with the thermally insulating body 72.

FIG. 6 is a front view of the set of rollers 48 engaged with the thermal break 70, in accordance with some embodiments. In FIG. 6, the set of rollers 48 are isolated from the panel 30 (e.g., as shown in FIG. 2). The panel 30 may be coupled to the frame 12 (e.g., at the lower rail member 18) and include the set of rollers 48 coupled to the bottom side 34 of the panel 30 (e.g., as shown in FIG. 2). FIG. 6 shows the engagement of the set of rollers 48 and the thermal break 70 proximate to the first end 51 of the lower rail member 18 at the first track 54a. Although the first track 54a is shown, the other tracks in the plurality of tracks 54 may be substantially similar. In some embodiments, the set of rollers 48 engages the set of rollers 48 at an intermediate portion 74 of the body of thermally insulating material 72.

FIG. 7 is an end view or sectional view of the thermal break 70 isolated from the lower rail member 18, in accordance with some embodiments. The body of thermally insulating material 72 may include material that has a lower thermal conductivity or lower heat energy transfer than the material of the first and second lower rail members 58, 60. In some embodiments, the first and second lower rail members 58, 60 are comprised of metal (e.g., aluminum). In some embodiments, the body of the thermally insulating material 72 includes a polymer (e.g., polyamide and/or polyurethane), fiberglass, or a combination of the two (e.g., polyurethane based fiberglass). The thermal break 70 may include such materials to reduce heat loss through the frame 12 at the lower rail member 18. For example, the inclusion of thermally insulating materials (e.g., polyamide, polyurethane, or fiberglass) help reduce natural heat transfer that occurs in air. Therefore, the presence of the thermal break 70 may provide better insulation performance than air-filled spaces alone. When the fenestration unit 10 is situated proximate to an exterior of a building structure (e.g., outside), the thermal break 70 may improve insulation. For example, the thermal break 70 may help reduce heat from escaping the inside of the building structure in the winter. For example, the thermal break 70 may help prevent heat from entering the inside of a building structure in the summer. This leads to improved insulation at the fenestration unit 10, which may lead to home energy savings.

Further to FIG. 7, in some embodiments, the intermediate portion 74 of the body of thermally insulating material 72 may define a convex crown 84. The convex crown 84 may define a roller track (e.g., a head of the first track 54a) along a length of the convex crown 84 (e.g., wherein the length of the convex crown 84 extends from the first end 51 to the second end 53 of the lower rail member 18). The roller track may be configured to engage with the set of rollers 48 of the panel 30 (e.g., as shown in FIG. 6). The set of rollers 48 may be slidable along a length of the convex crown 84. In some embodiments, a cap member 82 may be coupled (e.g., removably coupled) to the convex crown 84. In other embodiments, the cap member 82 may be integral with the convex crown 84. The cap member 48 may be operable to engage (e.g., slidably engage) the set of rollers 48 of the panel 30 (e.g., as shown in FIG. 6) such that the set of rollers 48 can rotatably slide along the cap member 48. The cap member may optionally include a low-friction material. The cap member 82 may be substantially the same shape as the convex crown 84 (e.g., the cap member 82 and convex crown 84 may have a substantially similar profile). In some embodiments, the convex crown 84 may further define an upper shoulder 86 and a lower notch or recess 88 and the cap member 82 may further define a lower shoulder 89 and an upper notch 87. The upper shoulder 86 of the convex crown 84 may be complementary in shape to the upper notch 87 of the cap member 82, which may provide one point of retention and coupling for the thermal break and the cap member 82. Similarly, the lower notch 88 of the convex crown 84 may be complementary in shape to the lower shoulder 89 of the cap member 82 to provide another point of retention and coupling for the thermal break 70 and the cap member 82. This may create a strong coupling to keep the thermal break 70 and cap member 82 coupled when the set of rollers 48 moves across the roller track. As shown in FIG. 7, the cap member 82 and the convex crown 84 may each define two shoulder and notch coupling points on either side of the intermediate portion (e.g., two shoulder and notch coupling points on a side proximate the first side portion 78 and two shoulder and notch coupling points on a side proximate the second side portion 80).

Further to FIG. 7, in some embodiments, the intermediate portion 74 of the body of thermally insulating material 72 defines a rounded opening 102. The rounded opening 102 may removably couple to the end plate 52 of the fenestration unit 10 (e.g., with fasteners 56 as shown in FIGS. 4A-4B). The rounded opening 102 may be configured to receive the fastener 56 to removably couple to the end plate 52 (e.g., as shown in FIGS. 4A-4B).

Further to FIG. 7, in some embodiments, the first side portion 78 of the body of thermally insulating material 72 defines a first protrusion 90. The first protrusion 90 may extend substantiality horizontally relative to the intermediate portion of the body of thermally insulating material 72 (e.g., along the horizontal axis X) such that the first protrusion 90 is a horizontal protrusion. In some embodiments, the first protrusion 90 extends substantially perpendicularly to the intermediate portion 74. The first protrusion 90 may be configured to couple to at least one of the first and second lower rail members 58, 60 (e.g., as shown in FIG. 5). In the embodiment of FIG. 5, the first protrusion 90 is coupled to the first lower rail member 58 at a first coupling 91, however the reverse configuration is also contemplated where the first protrusion 90 is coupled to the second lower rail member 60. The first protrusion 90 may define a flared end 92. The flared end 92 may be configured to engage with a complementary recess defined in the first lower rail member 58 (e.g., as shown in FIG. 5) to couple to the first lower rail member 58 at the first coupling 91. The first coupling 91 between the thermal break 70 and the first lower rail member 58 may provide resistance to displacement (e.g., rotation) of the thermal break 70 due to movement of the panel 30 and help retain the thermal break 70 within the space 82. Although the embodiments herein discuss one first protrusion 90 on the first side portion 78, any number of protrusions (e.g., horizontal protrusions, vertical protrusions, and/or angularly offset protrusions) may extend from the first side portion 78.

Further to FIG. 7, in some embodiments, the second side 80 of the body of thermally insulating material 72 defines a second protrusion 94. The second protrusion 94 may extend substantiality horizontally relative to the intermediate portion of the body of thermally insulating material 72 (e.g., along the horizontal axis X) such that the second protrusion is a horizontal protrusion. The second protrusion 94 may extend along the same plane as the first protrusion 90 (e.g., such that the first and second protrusions 90, 94 extend along the same plane). In some embodiments, the second protrusion 94 extends substantially perpendicularly to the intermediate portion 74. The second protrusion 94 may be configured to couple to at least one of the first and second lower rail members 58, 60 (e.g., as shown in FIG. 5). In the embodiment of FIG. 5, the second protrusion 94 is coupled to the second lower rail member 60 at a second coupling 95, however the reverse configuration is also contemplated where the second protrusion 94 is coupled to the first lower rail member 58. The second protrusion 94 may define a flared end 96. The flared end 96 may be configured to engage with a complementary recess defined in the second lower rail member 60 (e.g., as shown in FIG. 5) to couple to the second lower rail member 60 at the second coupling 95. The second coupling 95 between the thermal break 70 and the second lower rail member 60 may provide resistance to displacement (e.g., rotation) of the thermal break 70 due to movement of the panel 30 and help retain the thermal break 70 within the space 82.

In some embodiments, the second side 80 may further define a third protrusion 98. The third protrusion 98 may extend substantiality parallel to the intermediate portion 74 of the body of thermally insulating material 72. The third protrusion may extend along the vertical axis Y such that the third protrusion 98 is a vertical protrusion. In some embodiments, the third protrusion 98 is integral with, and projects from, the second protrusion 94. The third protrusion 98 may project substantially perpendicularly to the second protrusion 94. The third protrusion 98 may be configured to couple to at least one of the first and second lower rail members 58, 60 (e.g., as shown in FIG. 5). In the embodiment of FIG. 5, the third protrusion 98 is coupled to the second lower rail member 60 at a third coupling 99, however the reverse configuration is also contemplated where the third projection 98 projects from the first protrusion 90 and is coupled to the first lower rail member 58. In some embodiments, the third protrusion 98 may include a shaped end 100. The shaped end 100 may be a curved or hooked shaped end. The shaped end 100 may be configured to engage with a complementary shaped recess defined in the second lower rail member 60 (e.g., as shown in FIG. 5) to couple to the second lower rail member 60 at the third coupling 99. The third coupling 99 between the thermal break 70 and the second lower rail member 60 may provide resistance to displacement (e.g., rotation) of the thermal break 70 due to movement of the panel 30 and help retain the thermal break 70 within the space 82. Although the embodiments herein discuss the second protrusion 94 and the third protrusion on the second side 80, any number of protrusions (e.g., horizontal protrusions, vertical protrusions, and/or angularly offset protrusions) may extend from the second side 80.

In some embodiments, a length L1 of the first protrusion 90 is less than a length L2 of the second protrusion 94. However, the reverse configuration where the length L2 of the second protrusion 94 is less than the length L1 of the first protrusion 90 is also contemplated. In some embodiments, based at least in part on the difference between the length L1 the first side portion 78 and the length L2 of the second side 80, the first and second sides 78, 80 are asymmetrical about the X-Y plane (defined generally between the vertical axis Y and the horizontal axis X). In some embodiments, based at least in part on the inclusion of the third protrusion on the second side 80, the first side portion 78 and the second side 80 are asymmetrical about the X-Y plane.

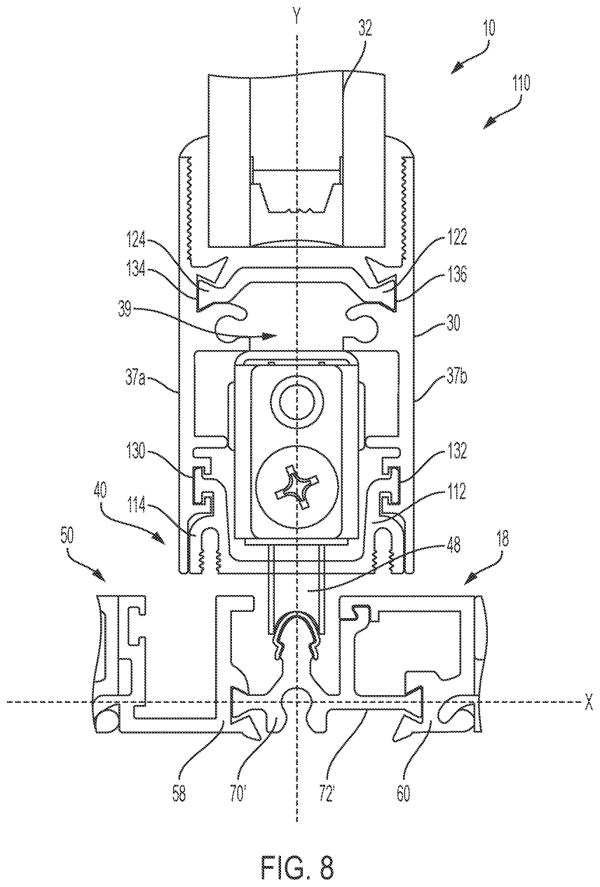

As shown in the sectional view of FIG. 8, the panel 30 may include a second thermal break 112 and a third thermal break 122. The lower rail member 18 of the frame 12 may include a first thermal break 70′ and, together, the first thermal break 70′, the second thermal break 112, and the third thermal break 122 form a thermal break system 110 of the fenestration unit. The thermal break system 110 as shown in FIG. 8 includes three discrete thermal breaks 70′, 112, 120, however, any number of thermal breaks may be included with the thermal break system 110. The panel 30 may include a first side 37a and a second side 37b which are defined along the vertical member 36 (e.g., on either side of the set of rollers 48). The first side 37a and the second side 37b may be metallic (e.g., aluminum). The first side 37a and the second side 37b may define a space 39 therebetween. For example, the set of rollers 48 may be located within the space 39 between the first side 37a and the second side 37b. The space 39 may further include at least a portion of the thermal break system 110. For example, a second thermal break 112 and a third thermal break 122 may be located within the space 39. The second thermal break 112 and the third thermal break 122 may be integral to the panel 30 or may be coupled to the panel 30. Similar to the thermal break 70 as described above, the second thermal break 112 and the third thermal break 112 may be permanently coupled to the panel 30 by crimping in place. The thermal break system 110 may provide similar benefits to that of the thermal break 70 (e.g., as described with respect to FIGS. 5-7). The thermal break system 110 may reduce heat loss through the panel 30 (e.g., reduce heat flow from the first side 37a to the second side 37b). The inclusion of the thermal break system 110 may also and also reduce the amount of un-filled space (e.g., air-filled space) within the space 39 to impede heat flow and/or national convection from the first side 37a to the second side 37b through the panel 30.

The thermal break system may include a first thermal break 70′, which may be substantially similar to the thermal break 70 of FIGS. 5-7. The first thermal break 70′ may be coupled lengthwise along the lower rail member 18 of the frame 12. The first thermal break 70 may be permanently coupled to the frame 12 by crimping in place. The first thermal break 70′ may include a first body of thermally insulating material 72′ that is asymmetrical about the X-Y plane. The first body of thermally insulating material 72′ may be substantially similar to the body of the thermally insulating material 72 of FIGS. 5-7. In this embodiment, the vertical axis Y may be defined along the first side 42 of the panel 30.

Further to FIG. 8, the thermal break system 110 may further include the second thermal break 112 defined lengthwise along the first side 42 of the panel 30 proximate to the lower side 40 of the panel. In some embodiments, the second thermal break 112 may extend lengthwise along the panel 30 from the first side 42 to the second side 44 of the panel 30. The second thermal break 112 may be located proximate to the set of rollers 48. In some embodiments, the second thermal break 112 extends lengthwise along the lower side 40 of the panel 30 across the set of rollers 48. The second thermal break 112 may include gaps along the length for the set of rollers 48 to extend through. The second thermal break 112 may include a second body of thermally insulating material 114. The second body of thermally insulating material 114 may be substantially symmetrical about an X-Y plane. The second body of thermally insulating material 114 may include material that has a lower thermal conductivity or lower heat energy transfer than the material of the panel 30 In some embodiments, the panel 30 comprises metal (e.g., aluminum). In some embodiments, the second body of the thermally insulating material 114 includes a polymer (e.g., polyamide or polyurethane), fiberglass, and/or a combination of the polymer and fiberglass (e.g., polyurethane based fiberglass). Similar to the thermal break 70, the second thermal break 112 may improve insulation of the building structure. In some embodiments, the first thermal break 70′ and the second thermal break 112 are aligned along an isothermal plane (e.g., a vertical plane defined generally along the first side 42 of the panel 30).

Further to FIG. 8, in some embodiments, the thermal break system 110 may further include the third thermal break 122. The third thermal break 122 may be defined lengthwise along the lower side 40 the panel 30 (e.g., extending between the first side 42 and the second side 44 of the panel 30) proximate to the glazing panel 32 (e.g., the insulated glass unit). In some embodiments, the third thermal break 112 is extends lengthwise along the glazing panel 32. The third thermal break 122 may include a third body of thermally insulating material 124. The third body of thermally insulating material 124 may be substantially symmetrical about the X-Y plane. Similar to the first and second thermal breaks 70′, 112, the third body of thermally insulating material 124 may include material that has a lower thermal conductivity or lower heat energy transfer than the material of the panel 30 In some embodiments, the panel 30 comprises metal (e.g., aluminum). In some embodiments, the third body of the thermally insulating material 124 includes a polymer (e.g., polyamide or polyurethane), fiberglass, and/or a combination of the polymer and fiberglass (e.g., polyurethane based fiberglass). Similar to the thermal break 70, the third thermal break 122 may improve insulation of the building structure. In some embodiments, the first thermal break 70′, the second thermal break 112, and the third thermal break 122 are aligned along the isothermal plane.

In some embodiments, the glazing panel 32 may be an insulated glass unit. The insulated glass unit may act as a fourth thermal break and comprise insulating materials. In some embodiments, the first thermal break 70′, the second thermal break 112, the third thermal break 122, and the glazing panel 32 are aligned along the isothermal plane.

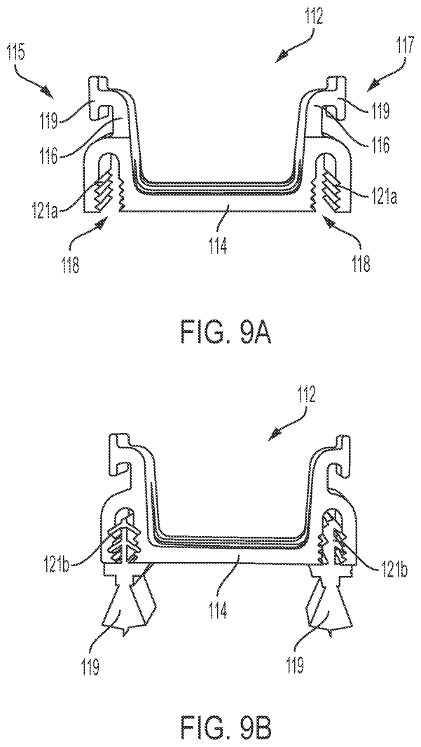

FIGS. 9A-9B are front views of the second thermal break 112 of FIG. 8. The second thermal break 112 includes the second body of thermally insulating material 114. In some embodiments, the second body of thermally insulating material 114 includes a first side 115 a and a second side 117. The first and second sides 115, 117 define a plurality of protrusions 116. The plurality of protrusions 116 may extend vertically and curve from the third body of thermally insulating material 114. The plurality of protrusions 116 may couple to the panel 30. Each protrusion in the plurality of protrusions 116 may define a shaped end 119. The shaped end 119 may be flared and shaped to couple to complementary shaped recesses in the panel 30. The set of shaped ends 119 may couple to the panel 30 at a second thermal break first side coupling 130 and a second thermal break second side coupling 132. The first side coupling 130 and the second side coupling 132 between the second thermal break 112 and the panel 30 may provide resistance to displacement (e.g., rotation) of the thermal break 70 due to movement of the panel 30 and/or the set of rollers 48 and help retain the thermal break 70 within the panel 30. The second body of thermally insulating material 114 may further define a plurality of recesses 118. The plurality of recesses 118 may be configured to couple to a set of seals 120 (e.g., as shown in FIG. 9B). The set of seals 119 may extend along the lower frame member 18. The set of seals 119 may include a weather seal or an additional thermal break. The recesses 118 may include a pattern 121a (e.g., a zig-zag pattern) to provide grip to the set of seals 119, where the set of seals include a complementary pattern 121b (e.g., as shown in FIG. 9B).

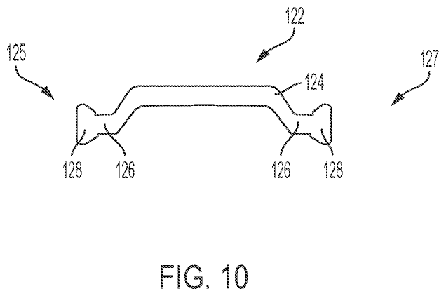

FIG. 10 is a front view of the third thermal break 122 of FIG. 8. The third thermal break 122 may include the third body of thermally insulating material 124. The third body of insulating material 124 may include a first side 125 and a second side 127. The first and second sides 125, 127 define a plurality of protrusions 126. The plurality of protrusions 126 may extend horizontally and outwardly from the third body of thermally insulating material 124 and couple to the panel 30. Each protrusion in the plurality of protrusions 126 may define a shaped end 128. The shaped end 119 may be flared and shaped to couple to complementary shaped recesses in the panel 30. The set of shaped ends 119 may couple to the panel 30 at a third thermal break first side coupling 134 and a third thermal break second side coupling 136. The first side coupling 134 and the second side coupled 136 between the thermal break 70 and the panel 30 may provide resistance to displacement (e.g., rotation) of the thermal break 70 due to movement of the panel 30 and help retain the thermal break 70 within the panel 30.

Various modifications and additions can be made to the exemplary embodiments discussed without departing from the scope of the present invention. For example, while the embodiments described above refer to particular features, the scope of the invention also includes embodiments having different combinations of features and embodiments that do not include all of the above-described features.

What is claimed is:

1. A fenestration unit comprising:
a frame including a plurality of frame members, wherein the plurality of frame members includes an upper rail member, a lower rail member, a first stile member, a second stile member, the lower rail member including two parallel metallic extrusions a space defined therebetween; and
a thermal break coupled to the lower rail member, the thermal break located within the space, the thermal break including,
a solid body of thermally insulating material defining a first side portion, a second side portion, and an intermediate portion between the first side portion and the second side portion, the solid body of thermally insulating material being asymmetrical about an X-Y plane.

2. The fenestration unit of claim 1, wherein the thermally insulating material includes at least one of polyamide, polyurethane, and fiberglass.

3. The fenestration unit of claim 1, wherein the thermal break is a solid, extruded member.

4. The fenestration unit of claim 1, further including a panel coupled to the frame, the panel including a set of rollers coupled to a bottom side of the panel, the set of rollers engaged with the thermal break.

5. The fenestration unit of claim 4, wherein the intermediate portion of the solid body of thermally insulating material defines a convex crown, the convex crown defining a roller track to engage the set of rollers of the panel.

6. The fenestration unit of claim 5, wherein the convex crown further includes a cap member coupled to the convex crown, the cap member operable to engage the set of rollers.

7. The fenestration unit of claim 6, wherein the cap member includes a low-friction material.

8. The fenestration unit of claim 1, wherein the first side portion of the solid body of thermally insulating material defines a first protrusion and the second side portion of the solid body of thermally insulating material defines a second protrusion, the first protrusion and the second protrusion configured to couple to at least one of the two parallel metallic extrusions of the lower rail member.

9. The fenestration unit of claim 1, wherein the intermediate portion of the solid body of thermally insulating material defines a rounded opening.

10. The fenestration unit of claim 9, wherein the rounded opening is configured to removably couple to an end plate of the fenestration unit.

11. A fenestration unit comprising:
a frame including a plurality of frame members, wherein the plurality of frame members includes an upper rail member, a lower rail member, a first stile member, a second stile member, the lower rail member including a first metallic extrusion and a second metallic extrusion positioned opposite the first metallic extrusion, the first and second metallic extrusions defining a space therebetween; and
a thermal break coupled to the lower rail member, the thermal break located within the space, the thermal break including,
a body of thermally insulating material defining a first side portion, a second side portion, and an intermediate portion between the first side portion and the second side portion,
wherein the first side portion defines a first horizontal protrusion coupled to the first metallic extrusion and the second side portion defines a second horizontal protrusion coupled to the second metallic extrusion, and
wherein the first side portion and the second side portion are asymmetrical about an X-Y plane.

12. The fenestration unit of claim 11, wherein a length of the first horizontal protrusion is less than a length of the second horizontal protrusion.

13. The fenestration unit of claim 11, wherein the second horizontal protrusion further includes a vertical protrusion projecting perpendicularly to the second horizontal protrusion.

14. The fenestration unit of claim 11, further including a sliding panel coupled to the frame, the sliding panel including a set of rollers coupled to a bottom side of the sliding panel, the set of rollers engaged with the thermal break.

15. A fenestration unit comprising:
a frame including a plurality of frame members, wherein the plurality of frame members includes an upper rail member, a lower rail member, a first stile member, a second stile member, the lower rail member including two metallic extrusions on either side of the rail with a space defined therebetween;
a panel coupled to the frame, the panel including an upper side defined along the upper rail member, a lower side defined along a lower rail member, a first side defined along the first stile member, and a second side defined along the second stile member, the panel including a set of rollers coupled along the lower side;
an insulated glass unit supported within the panel; and
a thermal break system defined along an isothermal plane of the fenestration unit, the thermal break system including,
a first thermal break coupled lengthwise along the lower rail member of the frame, the first thermal break including a first body of thermally insulating material, the first body being asymmetrical about a longitudinal axis, and
a second thermal break defined along a lower side of the panel proximate to the set of rollers, the second thermal break including a second body of thermally insulating material, wherein the first thermal break and the second thermal break are aligned along the isothermal plane.

16. The thermal break system of claim 15, wherein the second body of thermally insulating material includes a first side portion and a second side portion, the first side portion and the second side portion defining a plurality of protrusions configured to couple to the panel.

17. The thermal break system of claim 16, wherein the second body of thermally insulating material further includes a plurality of recesses is configured to receive a seal coupled lengthwise along the lower rail of the frame.

18. The thermal break system of claim 15, wherein the set of rollers is engaged with the first thermal break.

19. The thermal break system of claim 15, wherein the thermal break system further includes a third thermal break defined lengthwise along the panel proximate to the insulated glass unit.

20. The thermal break system of claim 19, wherein the first thermal break, the second thermal break, and the third thermal break are aligned along the isothermal plane.
